(19) United States
(12) Patent Application Publication
(10) Pub. No.: US 2011/0189629 A1
(43) Pub. Date: Aug. 4, 2011

(54) DENTAL MATRIX BAND

(75) Inventors: Beat Kilcher, Bosco Luganese (CH); Marco Da Rold, Odogno (CH)

(73) Assignee: KERRHAWE SA, Bioggio (CH)

(21) Appl. No.: 13/018,946

(22) Filed: Feb. 1, 2011

Related U.S. Application Data
(60) Provisional application No. 61/301,341, filed on Feb. 4, 2010.

(51) Int. Cl. A61C 5/04

(52) U.S. Cl. 433/39; 433/226

(57) ABSTRACT

The dental matrix band includes an elongated body having first and second opposing ends adapted to wrap around a tooth to be restored, and having first and second opposing longitudinal edges extending between the first and second opposing ends. The dental matrix band further includes a first line of weakness in the elongated body where the elongated body is separable along the first line of weakness. The dental matrix includes a fixture adjacent the first line of weakness. The dental matrix band may further include a second line of weakness. The dental matrix band may include an annealed section.

### CROSS-REFERENCE TO RELATED APPLICATIONS

Pursuant to 37 C.F.R. §1.78(a)(4), this application claims the benefit of and priority to prior filed co-pending Provisional Application Ser. No. 61/301,341, filed Feb. 4, 2010, which is expressly incorporated herein by reference in its entirety.

### TECHNICAL FIELD

This application generally relates to dental products, and in particular, to dental matrix bands.

### BACKGROUND

Dental matrix bands, commonly referred to as matrix strips, are relatively small thin elongated strips of flexible material that are used in various dental procedures. Generally, matrix bands are used to isolate or shield the sides of adjacent teeth from one another. For example, a dental procedure where matrix bands are commonly used is the restoration of Class II dental cavities or caries.

In the reconstruction of carious tooth surfaces, a tight anatomically self-contouring matrix band is preferred. This is particularly true at the interproximal, gingival and subgingival portion of the tooth to be rebuilt or restored. The matrix band acts as an anatomical tooth-encircling retaining wall for the filling material that replaces and restores the carious surfaces of a tooth to its original anatomy. The carious surfaces may be restored with silver amalgam, composites or other suitable material. The anatomically formed matrix band retains the shape of the restorative material until the filling material hardens, usually in minutes. Thereinafter, the matrix band is opened and removed from the tooth.

While contoured matrix bands are commonly used, they have been subject to numerous disadvantages. For example, matrix bands made from overly flexible and ductile materials may present problems during placement of the matrix band, especially where the interproximal distance is smaller than the thickness of the matrix band. Additionally, matrix bands of this type have required a tightening and retaining tool or the like to apply and hold them in position after they are placed on the tooth. Then, after completing the dental procedure, the matrix bands have to be opened with special cutting instruments, such as scissors and scalpels.

Thus, an improved dental matrix band that overcomes these and other problems of the prior art is desirable.

### SUMMARY OF THE INVENTION

The present invention overcomes the foregoing and other shortcomings and drawbacks of dental matrix bands heretofore known for use in dental restoration procedures. While the invention will be discussed in connection with certain embodiments, it will be understood that the invention is not limited to these embodiments. On the contrary, the invention includes all alternatives, modifications, and equivalents as may be included within the scope of the invention.

In one embodiment, a dental matrix band is provided that comprises an elongated body having first and second opposing ends adapted to wrap around a tooth to be restored, and having first and second opposing longitudinal edges extending between the first and second opposing ends; a first line of weakness in the elongated body intermediate the first and second opposing ends and extending substantially between the first and second opposing longitudinal edges, wherein the elongated body is separable along the first line of weakness; and a fixture adjacent the first line of weakness adapted to tear the elongated body along the first line of weakness when a sufficient force is applied to the fixture.

In another embodiment, a dental matrix band is provided that comprises an elongated body having first and second opposing ends adapted to wrap around a tooth to be restored, and having first and second opposing longitudinal edges extending between the first and second opposing ends; a first line of weakness in the elongated body intermediate the first and second opposing ends and extending substantially between the first and second opposing longitudinal edges, wherein the elongated body is separable along the first line of weakness; a second line of weakness in the elongated body spaced apart from the first line of weakness and extending substantially between the first and second opposing longitudinal edges, wherein a removable section is formed in the elongated body between the first and second lines of weakness; a fixture adjacent the first and second lines of weakness adapted to tear the elongated body along the first and second lines of weakness to separate the removable section from the elongated body when a sufficient force is applied to the fixture; and an annealed section in the elongated body intermediate the first and second opposing ends and spaced apart from the first and second lines of weakness, wherein the annealed section is more ductile than a remainder of the elongated body.

In yet another embodiment, a dental matrix band is provided that comprises an elongated body having first and second opposing ends adapted to wrap around a tooth to be restored, and having first and second opposing longitudinal edges extending between the first and second opposing ends; and an annealed section in the elongated body intermediate the first and second opposing ends, wherein the annealed section is more ductile than a remainder of the elongated body.

In yet another embodiment, a method of performing a dental restoration is provided that comprises applying a dental matrix band to a tooth to be restored, wherein the matrix band includes an elongated body having first and second opposing ends adapted to wrap around a tooth to be restored, and having first and second opposing longitudinal edges extending between the first and second opposing ends; and a first line of weakness in the elongated body intermediate the first and second opposing ends and extending substantially between the first and second opposing longitudinal edges, wherein the elongated body is separable along the first line of weakness; and a fixture adjacent the first line of weakness adapted to tear the elongated body along the first line of weakness when a sufficient force is applied to the fixture. The method further comprises tightening the matrix band on the tooth with a tensioning device; applying restoration material to the tooth; applying a sufficient force on the fixture to tear the elongated body along the first line of weakness thereby severing the elongated body between the first and second opposing ends; and removing the severed matrix band from around the tooth.

In yet another embodiment, a method of performing a dental restoration is provided that comprises applying a dental matrix band to a tooth to be restored, wherein the matrix band includes an elongated body having first and second opposing ends adapted to wrap around a tooth to be restored, and having first and second opposing longitudinal edges extending between the first and second opposing ends; and an annealed section in the elongated body intermediate the first and second opposing ends, wherein the annealed section is more ductile than a remaining portion of the elongated body. The method further comprises burnishing the annealed section with a burnishing tool to adapt the annealed section to an adjacent tooth; applying restoration material to the tooth; and removing the dental matrix band from around the tooth.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a side elevational view of a dental matrix band according to one embodiment of the invention, illustrating one line of weakness.

FIG. 2 is a side elevational view of a dental matrix band according to another embodiment of the invention, illustrating two lines of weakness.

FIG. 3 is a perspective view of the dental matrix band of FIG. 2 and a dental matrix tightener according to one embodiment of the invention.

FIG. 4 is a perspective view of the dental matrix band and tightener of FIG. 3 illustrating the matrix band placed and tightened on a tooth.

FIG. 5 is a perspective view of the matrix band shown in FIG. 4, following the partial tearing of the elongated body of the matrix band along the lines of weakness.

FIG. 6 is a perspective view of the matrix band shown in FIG. 4, showing a burnishing tool inserted into a Type II dental cavity.

FIG. 7 is a partially-transparent perspective view of the matrix band and burnishing tool shown in FIG. 6, illustrating the burnishing of an annealed section of the dental matrix band.

FIG. 8 is a perspective view of a dental matrix band according to one embodiment of the invention.

FIG. 9 is a perspective view of a dental matrix band according to another embodiment of the invention.

### DETAILED DESCRIPTION OF THE DRAWINGS

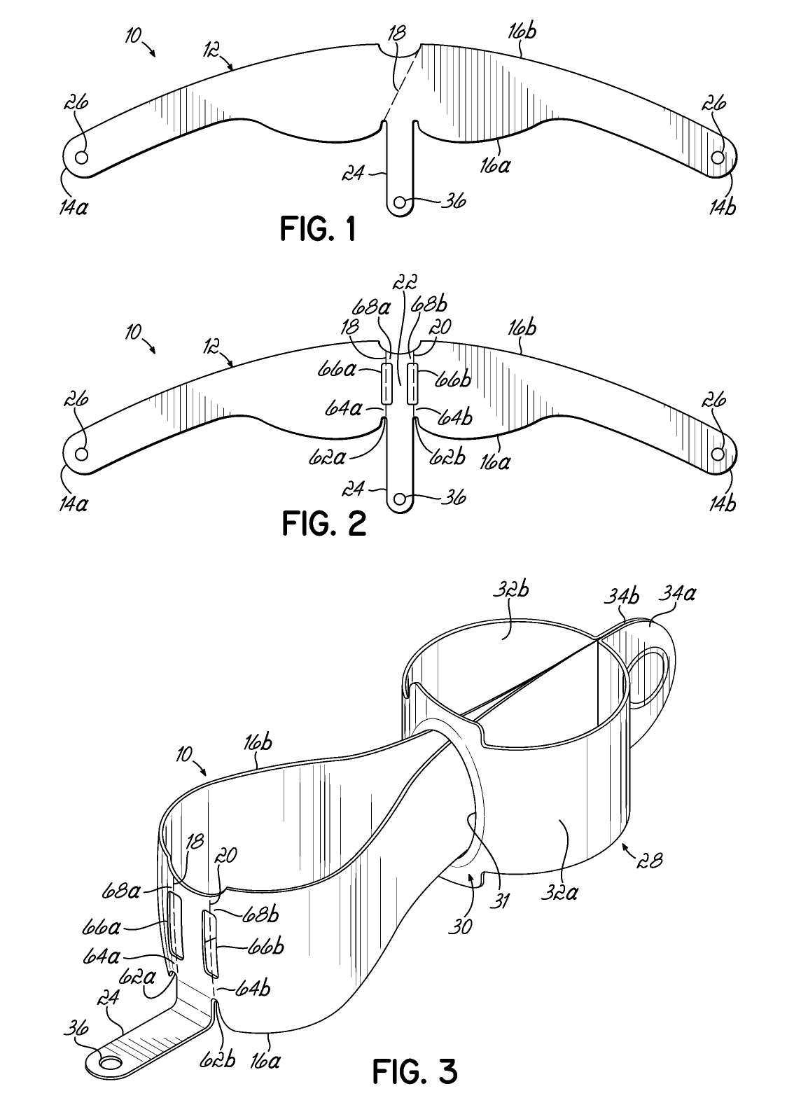

With respect to the figures, FIG. 1 illustrates a dental matrix band 10 according to one embodiment of the invention. The band 10 comprises an elongated body 12, first and second opposing ends 14a,b and first and second opposing longitudinal edges 16a,b. A first line of weakness 18 in the elongated body 12 lies between the first and second opposing ends 14a,b and extends substantially between the first and second opposing longitudinal edges 16a,b. A fixture 24 is adjacent the first line of weakness 18 and extends from longitudinal edge 16a.

The dental matrix band 10 may comprise a flexible material such as those commonly used within the art. Suitable materials include thermoplastics, such as polyesters, and metals, such as aluminum, titanium, iron and alloys thereof. Exemplary matrix band materials include polyethylene terephthalate (PET), aluminum, titanium, and stainless steel. Optionally, the matrix band material may further comprise a coating, such as a fluoropolymer, to impart favorable surface properties, such as reduced adhesion to the filling material.

The elongated body 12 may be in the form of a strip, wherein the opposing longitudinal edges 16a,b are approximately parallel. Alternatively, as shown in FIGS. 1-9, the body 12 may be contoured to provide an anatomical adaptation around a tooth 42 to be restored.

As shown in FIG. 2, the matrix band 10 may further comprise a second line of weakness 20 that is spaced apart (i.e., separated by a distance greater than zero) from the first line of weakness 18 to form a removable section 22 within the elongated body 12 of the dental matrix band 10. The fixture 24 is adjacent both the first and second lines of weakness 18, 20 and extends from longitudinal edge 16a of the removable section 22. The fixture 24 may be contiguous with or attached to the removable section 22.

The elongated body 12 is separable along a line of weakness. The phrase “line of weakness” as used herein defines a manufactured region for an intentional failure in the elongated body 12 that will tear or separate when a sufficient force (i.e., the opening force) is applied to the fixture 24. The amount of force to cause a line of weakness to fail may vary, but it is less than the adjoining regions of the elongated body 12. In other words, a line of weakness is designed to fail before the adjoining regions fail and requires less force to do so.

As used herein, the opening force (Fₒₚ) is the force required to separate the elongated body 12 along a line of weakness, and the force of failure (F_{f}) is the force required to separate the elongated body absent any line of weakness. According to one embodiment of the invention, the opening force (Fₒₚ) is less than about 80% of the force of failure (F_{f}), for example, less than about 70% of F_{f}, or less than about 60% of F_{f}. According to another embodiment, the Fₒₚ is less than about 50% of F_{f}, or less than about 25% of F_{f}. By way of further example, the Fₒₚ is about 10% to about 75% of F_{f}, or about 20% to about 60% of F_{f}, or about 25% to about 50% of F_{f}.

In FIGS. 1, 2, 8 and 9, the first line of weakness 18 is illustrated by a dashed line. It should be appreciated by one having ordinary skill in the art, that a line of weakness may comprise a scored line, a pattern of perforation, or a ductile region that is substantially more ductile than the adjacent longitudinal regions, wherein the line of weakness extends substantially between the first and second opposing longitudinal edges 16a,b. In one embodiment, first line of weakness 18 is a scored line. In another embodiment, first line of weakness 18 is a series of small holes, also known as a perforation line. In yet another embodiment, first line of weakness 18 is a series of spaced, end-to-end slits in the elongated body 12. In yet another embodiment, first line of weakness 18 is a linear region extending between the first and second longitudinal edges 16a,b that is significantly more ductile than the adjoining longitudinal regions. The second line of weakness 20, when present, may be the same or different than the first line of weakness 18. Moreover, the second line of weakness 20 may be parallel to the first line of weakness 18, or the lines of weakness 18, 20 may be non-parallel, such as the V-shape depicted in FIG. 9.

In reference to FIG. 3, the removable section 22 is contiguous with fixture 24. The first opposing longitudinal edge 16a is contoured to form notches 62a,b longitudinal to fixture 24. Sequentially transverse to notches 62a,b are wall sections 64a,b and 68a,b that are each separated by elongated apertures 66a,b. For example, in FIG. 2, the first line of weakness 18 is formed by the transverse sequence of a notch 64a, a first wall section 64a, an aperture 66a and a second wall section 68a, and the second line of weakness is formed by the transverse sequence of a notch 64b, a first wall section 64b, an aperture 66b and a second wall section 68b. In one embodiment, wall sections 64a,b and 68a,b are thinned relative to the thickness of adjacent sections of the elongated body 12.

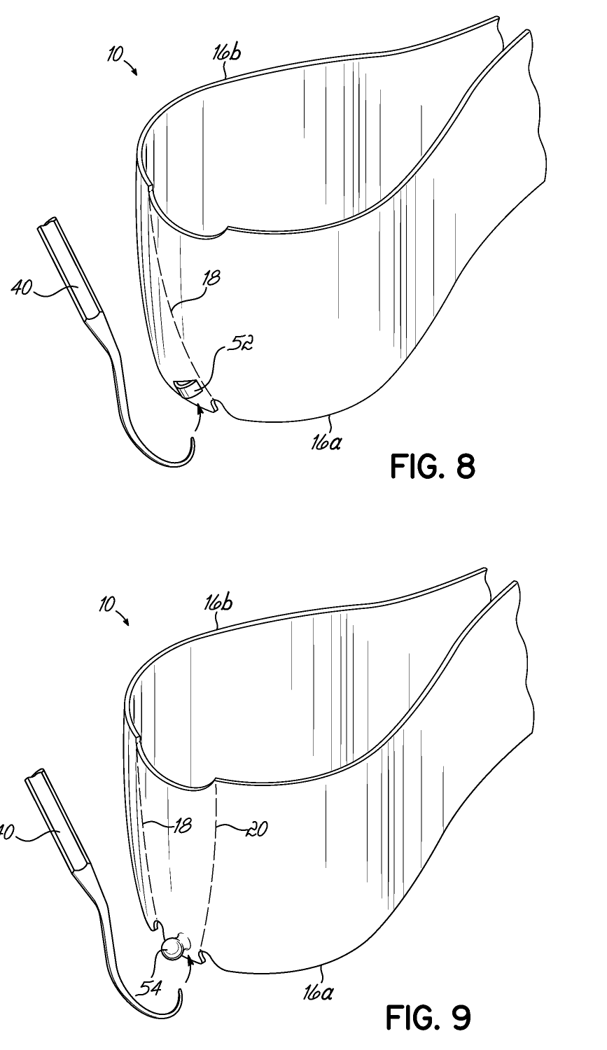

Fixture 24 is adjacent the first line of weakness 18 and is adapted to tear the elongated body 12 along the first line of weakness 18 when a sufficient force is applied to the fixture 24. The fixture 24 may be a tab that is contiguous with the elongated body 12 and continuous with the first longitudinal edge 16a, as shown in FIG. 1. The fixture 24 may also be attached to the elongated body 12. The fixture 24 may be attached by any suitable means, such as welding, fusing, gluing, crimping, and riveting, for example. The fixture 24 is not restricted to any particular shape, but may be configured to engage with a tool 40 suitable for applying the requisite force to tear the elongated body 12 along the first line of weakness 18, as will be discussed in more detail below with reference to FIG. 5. The fixture 24, in a specific embodiment, may be a handle 52 or knob 54 attached to the elongated body 12, as shown in FIGS. 8 and 9, respectively. With particular reference to FIGS. 1 and 2, the fixture 24 may include an aperture 36 configured to receive a tool 40 therein for applying force to the fixture 24. However, these fixtures are merely exemplary rather than intended to be limiting. Alternative fixtures may include any structure engagable by a standard dental instrument readily available to a dentist that is capable of applying a force sufficient to tear the fixture at the line(s) of weakness, thereby eliminating the need for special instruments to effect a removal of the band 10. Optionally, a notch or an equivalent thereof, as shown in FIGS. 1-9, may be present adjacent the fixture 24 at a terminus of the first and/or second line of weakness 18 (20) to facilitate focusing the applied force along the line(s) of weakness.

The opposing ends 14a,b may be adapted to facilitate attachment to a tensioning device, also known as a tightener. As shown in FIGS. 1 and 2, an aperture 26 may be formed in each of the opposing ends 14a,b to enable attachment to a tightener, such as the type disclosed in U.S. Pat. No. 4,824,365 to von Weissenfluh. For example, as shown in FIG. 3, a loop-shaped tightener 28 is attached to the dental matrix band 10 of FIG. 2. In one embodiment, the tightener 28 is a single strip having a central portion 30 between opposable deformable portions 32a,b that together form the loop. Two respective terminal end portions 34a,b extend from the deformable portions 32a,b to close the loop. The central portion 30 of the tightener 28 includes an opening 31 that slidably receives both first and second opposing ends 14a,b of the elongated body 12 between the deformable portions 32a,b. The respective terminal end portions 34a,b of the tightener 28 extend along each side of the first and second opposing ends 14a,b of the elongated body 12 and are fastened to the first and second opposing ends 14a,b to operably couple the opposing deformable portions 32a,b of the loop-shaped tightener 28 and the elongated body 12 of the dental matrix band 10. The tightener 28 comprises a material that may be permanently deformed by application of pressure to said opposing deformable portions 32a,b of said tightener 28. For example, the tightener 28 may comprise aluminum.

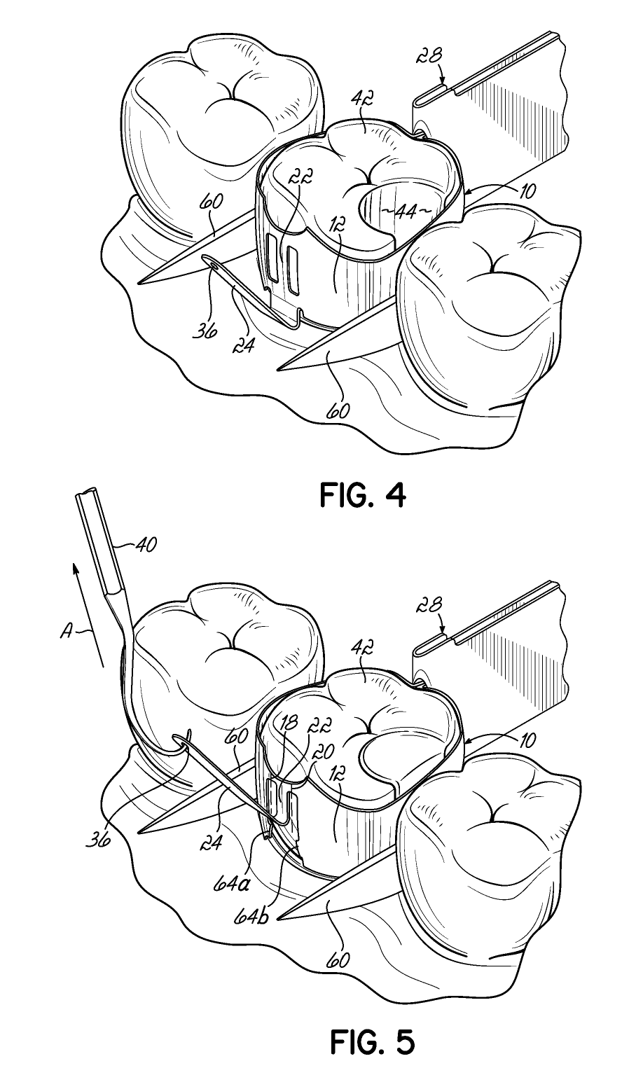

In particular reference to FIGS. 4 and 5, the dental matrix band 10 of FIGS. 2 and 3 is shown in surrounding relation on a tooth 42 having a dental cavity 44 and tightened thereon by tightener 28. Once the band 10 is tightened in place, the tooth 42 can then be restored by filling the cavity 44. Once restored, FIG. 5 illustrates a dental tool 40, such as an explorer, engaged with the aperture 36 of fixture 24 and applying a sufficient force, represented by line A, to the fixture 24 to partially tear the elongated body 12 along first and second lines of weakness 18, 20. The removable section 22 is shown partially removed from the elongated body 12 by the severance of the longitudinal edge 16a at the wall sections 64a,b. Once the tearing is complete and the removable section 22 has been removed by tool 40, the elongated body 12 is separated between the first and second opposing ends 14a,b and the separated or severed matrix band can be easily removed by pulling on the opposing ends 14a,b. The need for cutting instruments to cut the matrix band off the restored tooth is thereby eliminated.

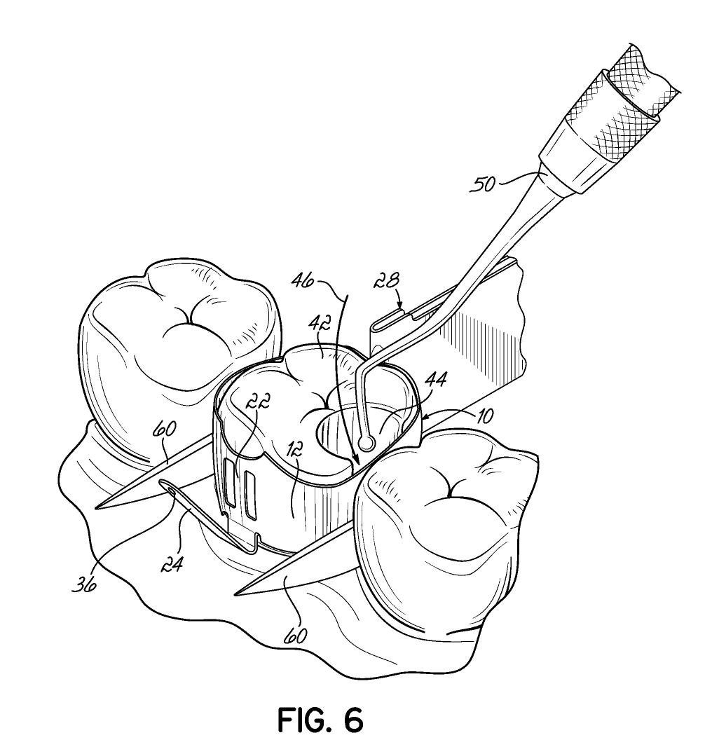

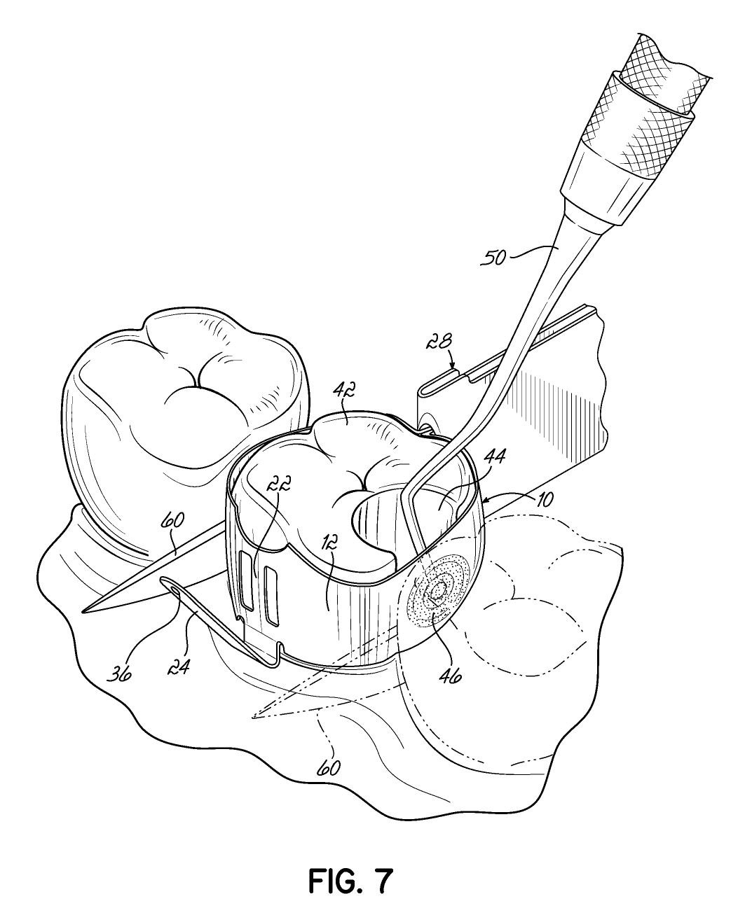

In accordance with another embodiment of the invention, FIGS. 6 and 7 depict a dental matrix band 10 further comprising an annealed section 46 between the first and second opposing ends 14a,b, wherein the annealed section 46 is more ductile than a remaining portion of the elongated body 12, i.e., more ductile than the non-annealed portions. In comparing ductility of the annealed section 46 to the remaining portion of the elongated body 12 that is not annealed, comparison should not be made to the portions of the elongated body that comprise the lines of weakness 18, 20, as those portions may themselves comprise ductile regions adapted to enable tearing of the elongated body 12 upon application of sufficient force to the adjacent fixture. Thus “remaining portion” refers to those portions of the elongated body that are neither lines of weakness 18, 20 nor annealed section 46. The annealed section is ideally located in a portion of the elongated body adapted to be placed between adjacent teeth in the proximal area adjacent the cavity 44, i.e., at the contact point between the restoration and the adjacent tooth. The annealed section 46 provides a ductile region that may be burnished with a burnishing tool 50. The ductile region may be shaped, i.e., inelastically deformed, which enables facile adaptation of the matrix band 10 in the proximal area. The non-annealed portion of the elongated body 12 maintains the stiffness needed for easy and reliable placement of the band 10.

Annealing may be accomplished by means commonly known in the art. An area of the elongated body 12 may be locally heated to an annealing temperature with a heating source under an inert atmosphere and subsequently followed by cooling. In one embodiment, an annealed section 46 was prepared in a dental matrix band 10 made of cold thread stainless steel having a tensile strength between about 1000 N/mm² to about 1500 N/mm², by performing a local annealing process with a heating source and under gas protection to avoid oxidation. To form the annealed section 46, a section of the elongated body 12 was heated to above 900° C. to convert the section of cold thread stainless steel to dead soft steel. The temperature, the atmospheric conditions, the manner of cooling and other annealing parameters may vary according to the properties of the material that comprises the elongated body 12.

In one embodiment, the annealed section 46 does not extend to the first and second opposing longitudinal edges 16a,b. Maintaining a non-annealed region adjacent the opposing longitudinal edges 16a,b facilitates improved performance as the dental matrix band 10 is placed on the tooth 42 through the contact point with the adjacent tooth. In embodiments further having line(s) of weakness 18 (20), the annealed section 46 is spaced apart from the line(s) of weakness whereby the annealed section 46 may be positioned in the proximal space while the line(s) of weakness 18 (20) and fixture 24 are accessible at the buccal or lingual surface of the tooth 42. It may be understood that embodiments having a line of weakness 18 and embodiments having an annealed section 46 may be combined as shown in FIGS. 6 and 7, or either embodiment may be used without the other, each offering its own benefits.

In further reference to FIGS. 6 and 7, the dental matrix band 10 comprising an annealed section 46 is shown in surrounding relation on a tooth 42 having a dental cavity 44. The annealed section 46 is positioned to be within the interproximal space. Once the matrix band 10 is positioned, it may be secured in place using interdental wedges 60 and a tightener 28, as shown. In an alternative embodiment, which is not shown, the matrix band 10 may be secured using only interdental wedges 60. The annealed section 46 may be burnished with a burnishing tool 50 to form the ductile region to the contour of the adjacent tooth. The dental cavity 44 may be filled with any suitable restoration material. Following completion of filling the cavity 44, the dental matrix band 10 may be removed.

The dental matrix band 10 according to embodiments of the invention is not restricted from use with other dental devices and equipment. Instead, the dental matrix band 10 may be used in conjunction with other dental equipment, such as interdental wedges 60, as shown in FIGS. 4-7.

While the invention has been illustrated by the description of one or more embodiments thereof, and while the embodiments have been described in considerable detail, they are not intended to restrict or in any way limit the scope of the invention to such detail. The various features shown and described herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. A dental matrix band comprising:
an elongated body having first and second opposing ends adapted to wrap around a tooth to be restored, and having first and second opposing longitudinal edges extending between said first and second opposing ends;
a first line of weakness in said elongated body intermediate said first and second opposing ends and extending substantially between said first and second opposing longitudinal edges, wherein said elongated body is separable along said first line of weakness; and
a fixture adjacent said first line of weakness adapted to tear said elongated body along said first line of weakness when a sufficient force is applied to said fixture.

2. The dental matrix band of claim 1, wherein said fixture includes a tab, a handle or a knob.

3. The dental matrix band of claim 2, wherein said fixture is a tab that is continuous with said first longitudinal edge.

4. The dental matrix band of claim 2, wherein said fixture is a tab attached to said elongated body.

5. The dental matrix band of claim 1, wherein said fixture comprises an aperture configured to receive a tool therein for applying said sufficient force.

6. The dental matrix band of claim 1, further comprising:
a second line of weakness in said elongated body spaced apart from said first line of weakness and extending substantially between said first and second opposing longitudinal edges, wherein a removable section is formed in said elongated body between said first and second lines of weakness.

7. The dental matrix band of claim 6, wherein said second line of weakness is approximately parallel to said first line of weakness.

8. The dental matrix band of claim 6, wherein said removable section comprises said fixture.

9. The dental matrix band of claim 1, wherein said first line of weakness comprises a score, a pattern of perforation, or a ductile region that is substantially more ductile than adjacent longitudinal regions, wherein said line of weakness extends between said first and second opposing longitudinal edges.

10. The dental matrix band of claim 1, wherein said elongated body comprises a metal.

11. The dental matrix band of claim 10, wherein said metal is selected from the group consisting of aluminum, titanium, iron and alloys thereof.

12. The dental matrix band of claim 1, wherein said elongated body further comprises an annealed section between first and second opposing ends and spaced apart from said first line of weakness, wherein said annealed section is more ductile than a remaining portion of said elongated body.

13. The dental matrix band of claim 1 further comprising:
a loop-shaped tightener attached to said elongated body, said tightener comprising a single strip having a central portion between opposable deformable portions that extend therefrom and terminate in respective end portions, said central portion of said tightener including an opening which slidably receives both said first and second opposing ends of said elongated body, and said respective end portions extending along and coupled to said first and second opposing ends of said elongated body to form said opposing deformable portions around said first and second opposing ends.

14. The dental matrix band of claim 1 further comprising:
a second line of weakness in said elongated body spaced apart from said first line of weakness and extending substantially between said first and second opposing longitudinal edges, wherein a removable section is formed in said elongated body between said first and second lines of weakness, wherein said fixture is adjacent said first and second lines of weakness, and wherein said fixture is adapted to tear said elongated body along said first and second lines of weakness to separate said removable section from said elongated body when the sufficient force is applied to said fixture; and
an annealed section in said elongated body intermediate said first and second opposing ends and spaced apart from said first and second lines of weakness, wherein said annealed section is more ductile than a remaining portion of said elongated body.

15. The dental matrix band of claim 14 further comprising:
a loop-shaped tightener attached to said elongated body, said tightener comprising a single strip having a central portion between opposable deformable portions that extend therefrom and terminate in respective end portions, said central portion of said tightener including an opening which slidably receives both said first and second opposing ends of said elongated body, and said respective end portions extending along and coupled to said first and second opposing ends of said elongated body to form said opposing deformable portions around said first and second opposing ends.

16. A dental matrix band comprising:
an elongated body having first and second opposing ends adapted to wrap around a tooth to be restored, and having first and second opposing longitudinal edges extending between said first and second opposing ends; and
an annealed section in said elongated body intermediate said first and second opposing ends, wherein said annealed section is more ductile than a remaining portion of said elongated body.

17. The dental matrix band of claim 16 further comprising:
a loop-shaped tightener attached to said elongated body, said tightener comprising a single strip having a central portion between opposable deformable portions that extend therefrom and terminate in respective end portions, said central portion of said tightener including an opening which slidably receives both said first and second opposing ends of said elongated body, and said respective end portions extending along and coupled to said first and second opposing ends of said elongated body to form said opposing deformable portions around said first and second opposing ends.

18. A method of performing a dental restoration comprising:
applying a dental matrix band to a tooth to be restored, wherein said matrix band comprises:
an elongated body having first and second opposing ends adapted to wrap around a tooth to be restored, and having first and second opposing longitudinal edges extending between said first and second opposing ends;
a first line of weakness in said elongated body intermediate said first and second opposing ends and extending substantially between said first and second opposing longitudinal edges, wherein said elongated body is separable along said first line of weakness; and
a fixture adjacent said first line of weakness adapted to tear said elongated body along said first line of weakness when a sufficient force is applied to said fixture;
tightening said matrix band on said tooth with a tensioning device;
applying restoration material to said tooth;
applying a sufficient force on said fixture to tear said elongated body along said first line of weakness thereby severing said elongated body between said first and second opposing ends; and
removing said severed matrix band from around said tooth.

19. The method of claim 18, wherein the dental matrix band further comprises an annealed section in said elongated body intermediate said first and second opposing ends, wherein said annealed section is more ductile than a remaining portion of said elongated body, the method further comprising burnishing said annealed section with a burnishing tool to adapt said annealed section to an adjacent tooth.

20. The method of claim 18, wherein the dental matrix band further comprises:
a second line of weakness in said elongated body spaced apart from said first line of weakness and extending substantially between said first and second opposing longitudinal edges, wherein a removable section is formed in said elongated body between said first and second lines of weakness.
